(19) United States
(12) Patent Application Publication
(10) Pub. No.: US 2026/0310539 A1
(43) Pub. Date: Oct. 8, 2026

(54) A SYSTEM AND METHOD FOR DIAGNOSING AND SOLVING FAULTS IN PRODUCTION PLANTS

(71) Applicant: GEA PROCOMAC S.P.A., Sala Baganza (Parma) (IT)

(72) Inventors: Michele Maffini, Sala Baganza (IT); Donato Luca De Dominicis, Sala Baganza (IT)

(73) Assignee: GEA PROCOMAC S.P.A., Sala Baganza (Parma) (IT)

(21) Appl. No.: 19/483,110

(22) PCT Filed: May 2, 2024
(86) PCT No.: PCT/IB2024/054263

§ 371 Date: Nov. 10, 2025

(30) Foreign Application Priority Data
May 11, 2023 (IT) 10202300000459

(51) Int. Cl. G06F 11/07

(52) U.S. Cl. CPC G06F 11/079; G06F 11/0709; G06F 11/0793

(57) ABSTRACT

A system (100) for diagnosing and solving faults in production plants (1), the system (100) including:
a plurality of sensors (101a) arranged at the production plants (1) and configured to detect one or more physical parameters or variables;
a plurality of electronic devices (103b) associated to operators (103a) of each production plant (1);
a failure generator (101b) and a root cause detector (101c) configured to identify root causes of failure among the failure events generated by the failure generator (101b);
a processing unit (105) associated to each production plant (1) and configured to determine a proposed maintenance action (PMA) as a function of root causes of failure and to generate a proposed maintenance message to be transmitted to the electronic devices (103b) of the corresponding production plant (1);
an AI engine (108) configured to generate new proposed actions (NPA).

### TECHNICAL FIELD

The present invention relates to a system and method for diagnosing and solving faults in production plants.

The invention proposed here is used in the food industry, in particular in the bottling sector, or in the chemical, petroleum, pharmaceutical or cosmetic industry.

In particular, the proposed invention finds application in inspections and maintenance operations of a food processing or packaging line, where operators can be involved in collecting data at a plant level.

The invention also finds application in farm technologies, in particular in managing alarms within stables, and in heating and refrigerating industries.

Solutions are already known which allow controlling a process plant by means of interconnected devices configured to communicate with sensors distributed across the plant.

### BACKGROUND ART

Document EP 4113230 A1 discloses a method for controlling a food handling system by using an operator carried device. In particular, the solution comprises a plurality of production units provided with sensors, exchanging data both with a remote server and with the operator carried device.

Document U.S. Pat. No. 11,169,651 B2 discloses a mobile user interface for controlling a complex process plant.

Even if these known solutions facilitate collecting data at a plant level, there is felt the need to increase responsiveness in trouble shooting.

In fact, in a complex process plant a fault may propagate through the information and material flow pathways, which may lead to several alarms being reported to the operators in a short time, making it difficult for them to diagnose the root cause quickly. The effect is a long plant downtime and thus a loss of productivity.

This also calls for unnecessary maintenance checks to rule out failures that may have a low probability of being a root cause.

Focus here is on alarm management, which is a critical step in process safety and efficiency.

Alarm root cause detection methods have been proposed in process industries.

### DISCLOSURE OF THE INVENTION

In this context, the object of the present invention is to provide a system and method for diagnosing and solving faults in production plants, which overcome the problems of the prior art cited above.

In particular, the object of the present invention is to propose a system and method for diagnosing and solving faults in production plants, which are able to achieve a higher responsiveness during trouble shooting, i.e., allowing a quicker availability of data and information.

Another object of the present invention is to propose a system and method for diagnosing and solving faults in production plants which are more flexible and allow a more effective collection of data.

The stated technical task and specified aims are substantially achieved by a system for diagnosing and solving faults in production plants, the system comprising:
a plurality of sensors arranged at the production plants and configured to detect one or more physical parameters or variables;
a plurality of electronic devices associated to operators of each production plant;
a failure generator associated to each production plant which, in response to receiving the physical parameters or variables from the sensors of the corresponding production plant, is configured to generate failure events;
a root cause detector associated to each production plant and configured to identify root causes of failure among the failure events generated by the failure generator of the corresponding production plant;
a plant database associated to each production plant and configured to store the failure events generated by the failure generator and the root causes of failure identified by the root cause detector of the corresponding production plant;
a processing unit associated to each production plant and configured to determine at least one proposed maintenance action as a function of the root causes of failure stored in the plant database of the corresponding production plant, said processing unit being further configured to generate a proposed maintenance message configured to be transmitted to the electronic devices of the corresponding production plant, said proposed maintenance message being representative of the proposed maintenance action;
a fault feedback database associated to each production plant and configured to store the proposed maintenance actions and their rate of use by the operators and new operator actions introduced by the operators using the electronic devices;
a cross-fleet database configured to receive the rates of use of the proposed maintenance actions and the new operator actions from the fault feedback databases of the production plants;
an AI engine configured to generate new proposed actions upon receiving the new operator actions from the cross-fleet database;
a validation unit configured to validate the new proposed actions received from AI engine so as to transform them into proposed maintenance actions.

In particular, the system further comprises a company database configured to store further data. The AI engine is configured to receive data also from the company database.

According to an aspect of the invention, the cross-fleet database, the AI engine and the validation unit are remotely located from the production plants. Preferably, the validation unit comprises the AI engine.

According to an aspect of the invention, for each production plant the corresponding failure generator, root cause detector, plant database, processing unit and fault feedback database are arranged at the production plant.

In one example of application, the production plants are bottling plants for producing receptacles starting from parisons made of thermoplastic material, each bottling plant comprising a plurality of production units each of which is provided with one or more of said sensors.

According to one embodiment of the invention, the AI engine comprises a supervised machine learning model. For example, the supervised machine learning model is a regression model or a classification model.

According to another embodiment of the invention, the AI engine comprises an unsupervised machine learning model. For example, the unsupervised machine learning model comprises clustering or dimensionality reduction.

According to one aspect of the invention, each of said electronic devices has a graphical user interface loadable on a corresponding display of the electronic device and configured to receive input data from the operators.

According to one aspect of the invention, each of said electronic devices has an audio interface configured to acquire audio signals.

According to one aspect of the invention, each of said electronic devices has a video camera configured to acquire photos and/or videos.

The stated technical task and specified aims are substantially achieved by a method for diagnosing and solving faults in production plants where a plurality of sensors is arranged, the method comprising the following steps carried out in one or more of the production plants:
generating failure events in response to receiving values of physical parameters or variables detected by said sensors;
identifying root causes of failure among the failure events;
storing of the failure events and of the identified root causes of failure in a plant database;
determining at least one proposed maintenance action by processing the root causes of failure stored in the plant database;
generating a proposed maintenance message representative of the at least one proposed maintenance action and transmitting said proposed maintenance message to at least one electronic device for being displayed to an operator;
in response to a confirm by the operator of having adopted the proposed maintenance action, increasing a counter associated to said proposed maintenance action in a fault feedback database configured to store the proposed maintenance actions and their rate of use;
in response to the operator having adopted a maintenance action which differs from the proposed maintenance action, recording data of the adopted maintenance action in the fault feedback database,
   the method further comprising the following steps carried out in a server side in communication with the production plants:
receiving at a cross-fleet database the rates of use of the proposed maintenance actions and/or the adopted maintenance actions coming from the fault feedback databases of the production plants;
generating by an AI engine a new proposed action upon receiving an adopted maintenance action from the crosse fleet database;
evaluating the new proposed action before transforming it into a proposed maintenance action.

According to an aspect of the invention, the step of evaluating the new proposed action before transforming it into a proposed maintenance action comprises the steps of:
revising the new proposed action in response to a disapproval of the new proposed action;
storing the approved or revised proposed action in the cross-fleet database as a proposed maintenance action in response to an approval of the new proposed action or in response to a revision;
transmitting the proposed maintenance actions and their rates of use from the cross-fleet database to the fault feedback databases of the production plants;
receiving and storing in the fault feedback databases the proposed maintenance actions and their rates of use.

### BRIEF DESCRIPTION OF DRAWINGS

Further characteristics and advantages of the present invention will more fully emerge from the non-limiting description of a preferred but not exclusive embodiment of a system and method for diagnosing and solving faults in production plants, as illustrated in the accompanying drawings in which:

FIG. 1 illustrates a plurality of production plants in a schematic view;

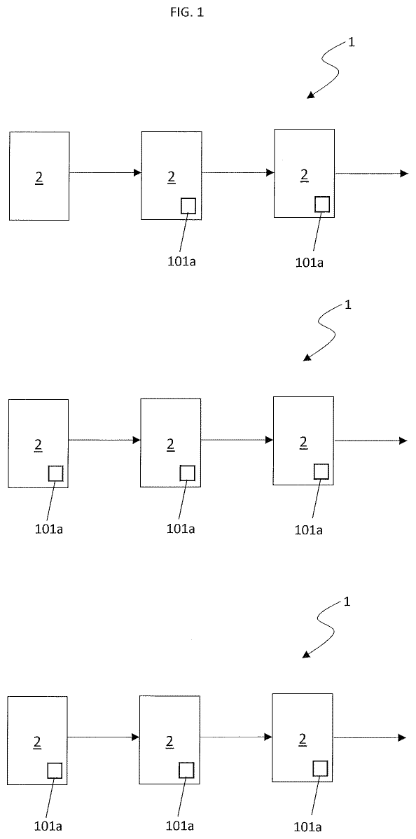

FIG. 2 illustrates a bottling plant in a schematic plain view;

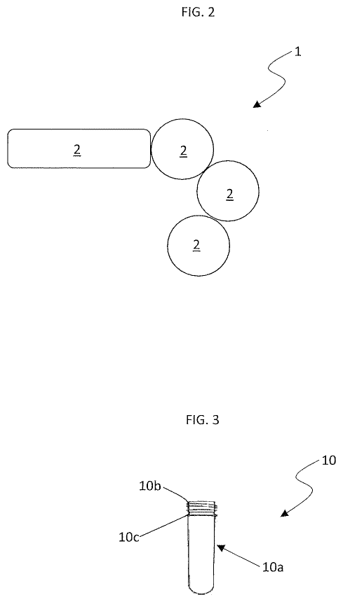

FIG. 3 illustrates a parison of thermoplastic material according to the prior art;

FIG. 4 illustrates a system for diagnosing and solving faults in production plants, in a schematic view, according to the present invention;

FIG. 5(a) is a flow-diagram of a method for diagnosing and solving faults in production plants, according to the present invention;

FIGS. 5(b) and 5(c) are a continuation of the flow-diagram of FIG. 5(a).

### DETAILED DESCRIPTION OF PREFERRED EMBODIMENTS OF THE INVENTION

With reference to the drawings, number 1 denotes production plants or manufacturing plants.

In particular, production plants 1 are located in different places.

According to one aspect of the invention, production plants 1 belong to the same company or to different companies.

For example, each production plant 1 is owned by a different owner.

Therefore, the production plants 1 may be located in different countries, subject to different laws and regulations.

Each production plant 1 comprises a plurality of production units 2.

According to an application of the invention, the production plants 1 are food processing plants 1.

In this context, a production unit 2 may be a processing unit, or a packaging unit or a transferring unit of the food processing plant 1.

More specifically, the production plants 1 are bottling plants for producing receptacles starting from parisons 10 made of thermoplastic material.

As it is well-known, a parison 10 has a tubular body 10a and a neck 10b (usually threaded) not subject to processing.

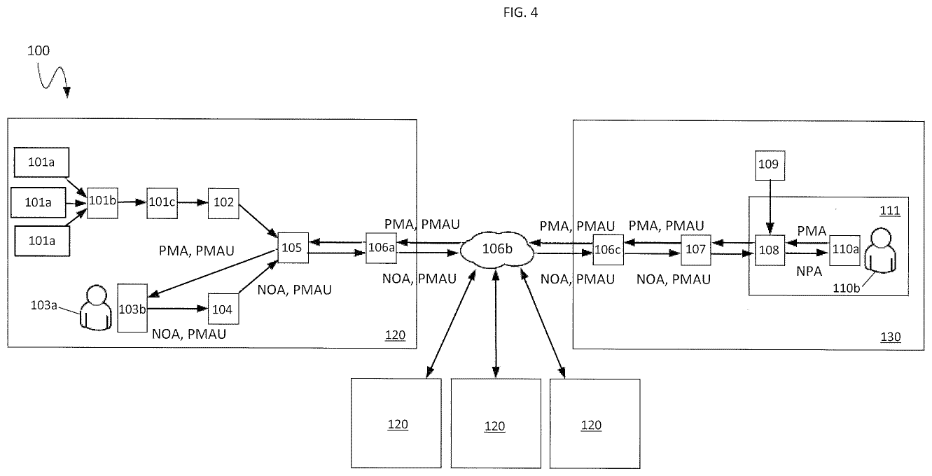

The neck 10b of each parison 10 has an annular protrusion 10c which is known in the art as a “bague”. A parison 10 is shown in FIG. 3.

The production units 2 of a bottling plant 1 are one or more of the following:
a moulding unit for forming parisons 10;
a heating unit or oven for heating the parisons 10;
a sterilizing unit for sterilizing the parisons 10;
a moulding unit for forming receptacles, for example by stretch-blowing of the parisons 10;
a sterilizing unit for sterilizing the receptacles;
a filling unit for filling the receptacles;
a capping unit for applying closures to the receptacles;
a labelling unit for applying labels to the receptacles;
a transferring unit, for example a transfer star-wheel or a linear conveyor.

It must be noticed this is a mere illustrative and non-limiting list. The bottling plant 1 may comprise only some of these production units 2.

Number 100 identifies a system for diagnosing and solving faults in production plants 1. In this contest, faults or failures are problems or abnormalities affecting production.

The system 100 comprises a plurality of sensors 101a arranged at the production plants 1 and configured to detect one or more physical parameters or variables.

As said, one application of the system 100 is for diagnosing and solving faults in bottling plants 1.

The bottling plants 1 managed by the same system 100 need not be identical. For example, one bottling plant 1 may be focused on the steps from heating parisons 10 to blowing them into receptacles, filling and capping them, whereas another bottling plant 1 also comprises the moulding of the parisons 10 starting from granules of thermoplastic material, etc.

According to one aspect, in each bottling plant 1 of the plurality of bottling plants, each production units 2 has one or more sensors 101a.

Alternatively, only some of the production units 2 have sensors 101a.

The sensors 101a may be chosen among one or more of the following: pressure transducers, level transducers, flow rate transducers, temperature sensors, encoders, valve position transducers, vibration transducers, etc.

The system 100 further comprises a plurality of electronic devices 103b associated to operators 103a that work in the production plant 1.

In this context, the electronic devices 103b may be fixed or mobile.

In particular, an electronic device 103b can be chosen among one of the following options: an industrial computer, a workstation, a tablet, a mobile phone, a wearable device (e.g., a smart watch or smart glasses).

The system 100 further comprises a failure generator 101b associated to each production plant 1.

According to one embodiment, each failure generator 101b is arranged in the corresponding production plant 1.

According to another embodiment, failure generators 101b may be remotely arranged with respect to the production plants 1. In the latter case, the failure generators 101b are in communication with the production plants 1 by any type of connection or network, for example a cloud connection.

There can also be envisaged embodiments with some failure generators 101b arranged in the corresponding production plants 1 and other failure generators 101b in cloud connection with the production plants 1.

In response to receiving the physical parameters or variables from the sensors 101a of the corresponding production plant 1, the failure generator 101b is configured to generate failure events.

In one example, the failure generator 101b is a Programmable Logic Controller.

The system 100 further comprises a root cause detector 101c associated to each production plant 1 and configured to identify root causes of failure among the failure events generated by the failure generator 101b of the corresponding production plant 1.

Preferably, the root cause detectors 101c are arranged in the corresponding production plants 1. Alternatively, the root cause detectors 101c are remotely located.

In this context, a root cause of failure is the primary reason a failure has occurred. It can also be addressed as a master failure event that has propagated throughout the production plant 1 thus generating a multiplicity of failures.

It must be noticed in a complex production plant 1 a root cause of failure may originate thousands of failures throughout the production plant 1. When the number of failures is so high the strategy to solve the failure shall start from identifying the root cause of failure.

To each production plant 1 is associated a plant database 102 configured to store the failure events generated by the failure generator 101b and the root causes of failure identified by the root cause detector 101c.

The plant database 102 is a historical database of failure events and root causes of failure of the corresponding production plant 1.

Preferably, the plant databases 102 are arranged in the corresponding production plants 1. Alternatively, the plant databases 102 are remotely located.

To each production plant 1 is associated a processing unit 105 which is configured to determine at least one proposed maintenance action PMA as a function of the root causes of failure stored in the plant database 102 of the corresponding production plant 1.

The processing units 105 may be arranged in the corresponding production plants 1 or may be remotely located.

The processing unit 105 is also configured to generate a proposed maintenance message which is representative of the proposed maintenance action PMA. The proposed maintenance action PMA and the relative message can be transmitted to one or more of the electronic devices 103b of the corresponding production plant 1. The electronic devices 103b are also configured to acquire input data from the operators 103a.

According to an embodiment of the invention, each electronic device 103b has a graphical user interface loadable on a corresponding display of the electronic device 103b and configured to receive input data from the operators 103a.

The data can be in the form of text, which is typed or handwritten by the operators 103a. In this context also selecting options from a multiple-choice box on the display or selecting icons is considered as inserting data.

Alternatively, or in addition, each electronic device 103b has an audio interface (i.e., a microphone) configured to acquire audio signals. For example, the operators 103a may record speeches relative to situations occurring in the production plant 1.

Alternatively, or in addition, each electronic device 103b is equipped with a video camera (or has an integrated one) configured to acquire photos and/or videos. For example, the operators 103a may take photos or videos of components of the productions plant 1.

To each production plant 1 is associated a fault feedback database 104 which is a historical database of the rate of use of the proposed maintenance actions, indicated as PMAU, for that specific production plant 1.

The fault feedback database 104 is configured to store the rate of use PMAU of the proposed maintenance actions PMA that have been originated over time in the corresponding production plant 1. In particular, each proposed maintenance action PMA is associated to a corresponding counter (PMAU), which indicates how many times the proposed maintenance action PMA has been actually adopted by the operators 103a to solve a specific root cause of failure.

The electronic devices 103b are also configured to receive the rate of use PMAU from the processing unit 105, together with the proposed maintenance actions PMA. This will be better explained in the description of the method.

The fault feedback database 104 is also configured to store new operator actions introduced by the operators 103a, as it will be better explained later.

In particular, the operator 103a may insert data on actual maintenance actions adopted for solving a failure. In this context, these actual maintenance actions are referred to as “new operator actions”, indicated as NOA.

The fault feedback database 104 is configured to also store the new operator actions NOA adopted by the operators 103a but not yet validated by the system 100.

All the components of the system 1 described so far are associated to a production plant side 120.

The system 100 further comprises a server side 130, which is preferably located remotely from the production plants 1.

These server side 130 is in communication with all the production plants 1. The communication may be established by any type of connection or network, for example a cloud connection 106b.

In particular, the production plant sides 120 of the production plants 1 are configured to communicate with the cloud connection 106b.

For example, the server side 130 may be the headquarter of the company who has manufactured the production plants 1. Thus, the server side 130 acts as a collector receiving data from the owners of the production plants 1. The received data are then processed at the server side 130, which generates and delivers maintenance strategies for the production plants 1. The strategies may also be improved over time in case where they are based on Machine Learning Techniques.

In particular, the system 100 comprises a cross fleet database 107 and an AI engine 108 which are in the server side 130.

According to one embodiment, the system 100 further comprises a validation unit 111 configured to validate the new operator actions NOA coming from the production plant 1 (in particular from the fault feedback databases 104).

The cross-fleet database 107 is configured to receive the data from the fault feedback databases 104 of all the production plants 1.

The cross-fleet database 107 is configured to compute and store the rates of use PMAU of the proposed maintenance actions PMA, and the new operator actions NOA coming from all the production plants 1.

The cross-fleet database 107 is also configured to store data relative to the production plants 1 and the production units 2. For example, when the production plant 1 is a bottling plant the cross-fleet database 107 contains data relative to the type of technology used, i.e., aseptic, non-aseptic, etc., or data relative to the specific machines of the bottling plant, such as sterilizing machine using peracetic acid or using hydrogen peroxide.

In the server side 130 there is also a company database 109.

According to a preferred embodiment, the company database 109 is configured to store data relative to the company who manages the server side 130, together with data of the owners of the production plants 1.

The inputs for the AI engine 108 are the data from the cross-fleet database 107 and, optionally, from the company database 109.

According to an embodiment, the AI engine 108 is based on a machine learning model.

According to another embodiment, the AI engine 108 comprises:
a non-supervised neural network configured to perform a semantic clusterization the failure events;
a classifier (for example based on a KNN algorithm) configured to classify the type of production plant;
a recommendation engine and/or collaborative filtering configured to define which is the most idoneous proposed maintenance action PMA for solving the failure event by updating the value of the rate of use PMAU.

In one example, the AI engine 108 comprises a supervised machine learning model, such as a regression model or a classification model

In another example, the AI engine 108 comprises an unsupervised machine learning model, such as clustering or dimensionality reduction.

In a preferred embodiment, the AI engine 108 is part of the validation unit 111.

In particular, during a training time, the AI engine 108 is trained to validate the new operator actions NOA and/or to associate these actions to failures which are different from the original one.

During inference time, upon receiving new operator actions NOA from the production plants 1, the AI engine 108 is configured to determine maintenance actions that might be completely brand-new with respect to already suggested actions. This will be better explained later.

According to another application of the invention, the production plants 1 are chemical or pharmaceutical plants.

According to another application of the invention, the production plants 1 are cosmetic plants.

According to another application of the invention, the production plants 1 are packaging plants.

According to another application of the invention, the production plants 1 are farms.

According to another application of the invention, the productions plants are heating or refrigerating plants.

A method for diagnosing and solving faults in production plants, according to the present invention, is described hereafter.

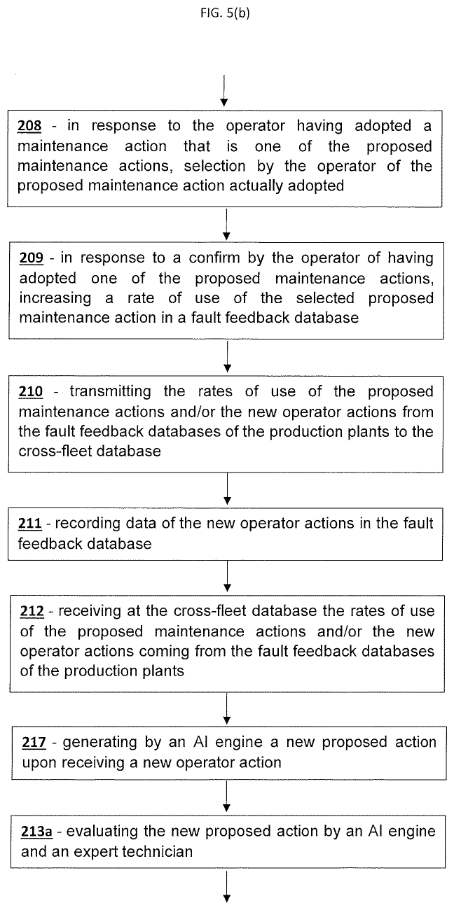

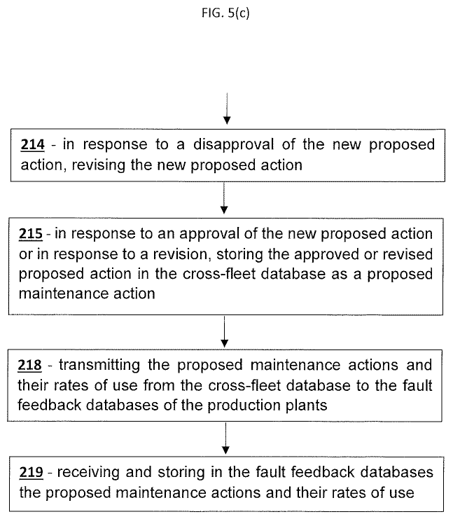

A flow-diagram of the method is illustrated in FIGS. 5(a) to 5(c), where the method is indicated with number 200.

In a preferred embodiment, the method 200 is carried out by the system 100 of the present invention.

As said, the sensors 101a are arranged at various production units 2 of each production plant 1. For the sake of simplicity, the following description refers to one of the production plants 1 only. The same steps may occur in all the production plants 1 that are managed by the system 100.

The sensors 101a detect values of physical parameters or variables, depending on the type of sensors.

The detected values are transmitted to the failure generator 101b.

In response to receiving the values detected by the sensors 101a, the failure generator 101b generates failure events (step 201).

The method 200 proceeds with identifying root causes of failure among the failure events (step 202).

In particular, the identification of the root causes of failure is carried out by the root cause detector 101c.

The failure events and the identified root causes of failure are stored to create a historical database (step 203). In particular, they are stored in the plant database 102 of the production plant 1.

The root causes of failure stored in the plant database 102 are processed to determine at least one proposed maintenance action PMA (step 204).

According to the illustrated embodiment, the step 204 is carried out by the processing unit 105 located in the production plant 1.

The processing unit 105 generates and transmits a proposed maintenance message representative of the proposed maintenance action PMA to the electronic devices 103b of the production plant 1.

According to an aspect of the invention, the processing unit 105 is configured to generate a plurality of proposed maintenance actions PMA, among which the operator 103a may choose.

As said, the proposed maintenance actions PMA are ranked by probability of success according to their rate of use collected from all the production plants 1.

The processing unit 105 receives the rates of use PMAU of the proposed maintenance actions PMA from the server side 130 and also transmits this data to the electronic devices 103b, together with the corresponding message.

In step 205 the proposed maintenance message is displayed on the electronic device 103b of an operator 103a, together with the failure event.

In step 206a the operator 103a receives a query on the electronic device 103b. In particular, the query is relative to a comparison between the actual maintenance action adopted by the operator 103a to solve the failure in the production plant 1 and the proposed maintenance action(s) PMA provided by the processing unit 105.

If the actual maintenance action adopted by the operator 103a coincides with one of the proposed maintenance actions PMA, then the operator 103a is asked to select which of the proposed maintenance actions PMA has been used (step 208).

In selecting the proposed maintenance action PMA, the operator 103a may be guided by data relative to the production plant 1 or to the production units 2 coming from the cross-fleet database 107.

Upon selecting one of the proposed maintenance actions PMA, the corresponding rate of use PMAU is incremented in the fault feedback database 104 (step 209).

The rates of use PMAU are then sent from the fault feedback databases 104 of all the production plants 1 to the cross-fleet database 107 (step 210).

If the actual maintenance action adopted by the operator 103a is not one of the proposed maintenance actions PMA, then the operator 103a is asked to insert data on the actual maintenance action adopted, which is in fact a new operator action NOA (step 207).

In particular, the operator 103a is requested to insert a summary of the new operator action NOA, for example by recording a speech or inserting text by the electronic device 103b.

Alternatively, or in addition, the operators 103a may take photos or videos of components of the productions plant 1 by means of the electronic device 103b.

The new operator action NOA is then stored in the fault feedback database 104 (step 211). This new operator action NOA introduced by the operator 103a is still considered a proposal to the system 100.

The new operator actions NOA are then sent from the fault feedback databases 104 of all the production plants 1 to the cross-fleet database 107 (step 210). As already explained, the production plants 1 communicates with the server side 130. The server side 130 is synchronized with the production plants 1.

In particular, to each production plant 1 is associated a data synchronization engine 106a and on the server side 130 there is a data synchronization manager 106c. The data synchronization manager 106c is in communication with the data synchronization engines 106a of all the production plants 1 by means of the cloud connection 106b.

Therefore, the rates of use PMAU of the proposed maintenance actions PMA coming from the fault feedback databases 104 of all the production plants 1 are received at the cross-fleet database 107 (step 212).

The new operator actions NOA coming from the production plants 1 are also received at the cross-fleet database 107 (step 212). These new operator actions NOA still have to be validated (i.e., approved) by the system 100. The validation is carried out by the validation unit 111.

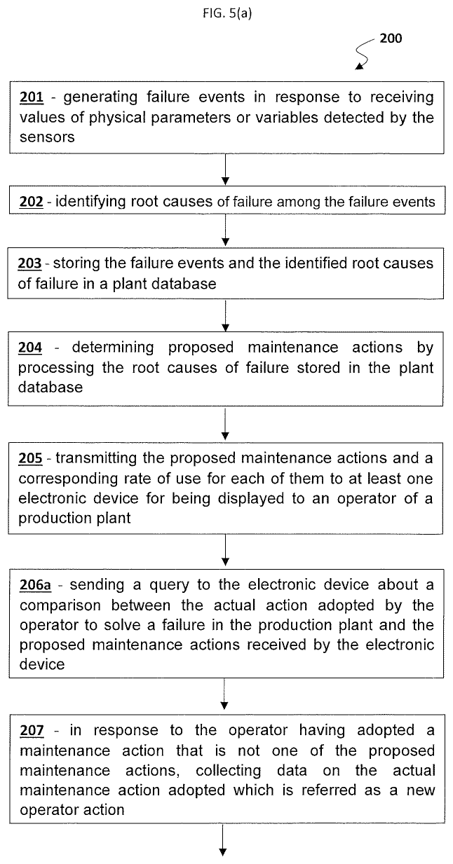

According to a preferred embodiment of the invention, shown in FIG. 4, the validation is started by the AI engine 108.

Upon receiving a new operator action NOA and data from the company database 109, the AI engine 108 is configured to generate a new proposed action NPA (step 217).

During a training phase of the AI engine 108, an expert technician 110b in a control room 110a evaluates the coherency of a new proposed action NPA with the specific failure that occurred. The expert technician 110b also evaluates whether the new proposed action NPA is sufficiently described (step 213a).

In response to an approval of the new proposed action NPA by the expert technician 110b, the new proposed action NPA becomes a proposed maintenance action PMA and is stored in the cross-fleet database 107 (step 215).

In response to a disapproval of the new proposed action NPA by the expert technician 110b, the new proposed action NPA is not immediately discarded. A step of revision 214 of the new proposed action is preferably carried out by the expert technician 110b, at the end of which the new proposed action NPA may indeed by validated, become a proposed maintenance action PMA and be stored in the cross-fleet database 107 (step 215). Thus, finally the cross-fleet database 107 is populated with the proposed maintenance actions PMA and the rates of use PMAU of the proposed maintenance actions PMA.

The proposed maintenance actions PMA and their rates of use PMAU are transmitted from the cross-fleet database 107 to the production plants 1 by means of the cloud connection 106b (step 218).

The proposed maintenance actions PMA and their rates of use PMAU are thus received and stored in the fault feedback databases 104 of the production plants (step 219).

During an inference time, the AI engine 108 is configured to create correlations between all the data coming from the plurality of production plants 1 and the data stored in the server side 130.

Indeed, upon receiving the data from the cross-fleet database 107 (including the proposed maintenance actions PMA and their rates of use PMAU) and from the company database 109, the AI engine 108 is configured to generate maintenance actions that may be completely brand-new and to send them to the production plants 1.

In particular, the AI engine 108 comprises another neural network, which is preferably a deep neural network configured to propose a new proposed action NPA to the expert technician 110b.

For this, text analytics (i.e., Jacard distance) may be used.

The method just described above involves the operators 103a as active subjects that, upon receiving proposed maintenance actions PMA, can decide whether to use one of them or to propose a new one.

It is also envisaged an alternative embodiment of the method, in which the operators 103a do not directly perform any direct action upon receiving a proposed maintenance action PMA. In this embodiment, the proposed maintenance action PMA triggers the generation of a command in a control unit that is configured to control a component of the production plant 1.

For example, the proposed maintenance action PMA is associated to the detection of a failure in a temperature setting in an oven of a bottling plant 1. Thus, the proposed maintenance action PMA triggers the generation of a command of “increasing the temperature” in the oven.

In an alternative embodiment, the AI engine 108 will be based on transformers (chatbot) configured to directly propose the proposed maintenance action PMA without any processing by the expert technician 110b.

In an alternative embodiment, the AI engine 108 is configured to validate the new operator actions NOA coming from the production plant 1 (in particular from the fault feedback databases 104). In this alternative embodiment, there is no need for a separate validation unit and no expert technician is involved for evaluating the coherency of a new proposed action NPA with the specific failure that occurred.

A brief example of how the proposed system 100 can work when applied to a bottling plant 1 is introduced hereafter, with reference to a fault raised in one of its production units 2 (the bottle sterilizer).

After the periodical overhaul, a fault is raised in the bottle sterilizer. In particular, the bottles sterilizer has a phase shift with respect to all the other production units of the line.

This fault is not easily recognizable, but a sensor 101a associated to the bottle sterilizer is configured to check the efficiency of the nozzles used to spray the sterilizing agent to the bottles. Due to the phase shift of the bottle sterilizer, the sensor 101a detects an abnormal value, which means the nozzles are not performing properly.

The system 100 suggests some possible solutions (proposed maintenance action PMA), such as checking the pressure of the liquid used to sterilize bottles and checking if the nozzle is clogged.

These proposed maintenance actions PMA are provided to a line operator 103a by means of an electronic device 103b, for example a tablet.

Nevertheless, neither of the proposed actions is able to solve the fault.

Thus, the line operator 103a decides to perform a new operator action NOA, that is changing the position of the sensor 101a. The line operator 103a inserts a description of the new operator action NOA on the tablet 103b and then submits this feedback to the server side 130.

The AI engine 108 analyses the fault and the new operator action NOA performed by the operator 103a and generates a new proposed action NPA.

The validation unit 111 evaluates the new proposed action NPA and finds that the fault was not properly addressed. The fault can be solved only repositioning the machine position sensor (encoder).

Therefore, the new proposed action NPA is revised, stored in the cross-fleet database 107 as a possible solution for that specific fault and sent back to the operator 103a.

The characteristics of the system and method for diagnosing and solving faults in production plants, according to the present invention, are clear, as are the advantages.

In particular, each production plant contributes to give feedbacks on failures to the server side. At the same time, each production plant benefits from being connected to the central server side since it receives validated operator actions ranked by probability of success, which are generated in other production plants.

The use of a machine learning model allows to continually improve the creation of proposed maintenance actions which can be delivered to solve failures in the production plants.

1. A system for diagnosing and solving faults in production plants, the system comprising:
a plurality of sensors arranged at the production plants and configured to detect one or more physical parameters or variables;
a plurality of electronic devices associated to operators of each production plant;
a failure generator associated to each production plant which, in response to receiving the physical parameters or variables from the sensors of the corresponding production plant, is configured to generate failure events;
a root cause detector associated to each production plant and configured to identify root causes of failure among the failure events generated by the failure generator of the corresponding production plant;
a plant database associated to each production plant and configured to store the failure events generated by the failure generator and the root causes of failure identified by the root cause detector of the corresponding production plant;
a processing unit associated to each production plant and configured to determine at least one proposed maintenance action as a function of the root causes of failure stored in the plant database of the corresponding production plant, said processing unit being further configured to generate a proposed maintenance message configured to be transmitted to the electronic devices of the corresponding production plant, said proposed maintenance message being representative of the proposed maintenance action;
a fault feedback database associated to each production plant and configured to store the proposed maintenance actions and their rate of use by the operators and new operator actions introduced by the operators using the electronic devices;
a cross-fleet database configured to receive the rates of use of the proposed maintenance actions and the new operator actions from the fault feedback databases of the production plants;
an AI engine configured to generate new proposed actions upon receiving the new operator actions from the cross-fleet database.

2. The system according to claim 1, further comprising a validation unit configured to validate the new proposed actions received from AI engine so as to transform them into proposed maintenance actions

3. The system according to claim 1, further comprising a company database configured to store further data, said AI engine being configured to receive data also from the company database.

4. The system according to claim 1, wherein the cross-fleet database, the AI engine and the validation unit are remotely located from the production plants, the validation unit comprising the AI engine.

5. The system according to claim 1, wherein for each production plant the corresponding failure generator, root cause detector, plant database, processing unit and fault feedback database are arranged at the production plant.

6. The system according to claim 1, wherein the production plants are bottling plants for producing receptacles starting from parisons made of thermoplastic material, each bottling plant comprising a plurality of production units each of which is provided with one or more of said sensors.

7. The system according to claim 1, wherein the AI engine comprises a supervised machine learning model.

8. The system according to claim 7, wherein said supervised machine learning model is a regression model or a classification model.

9. The system according to claim 1, wherein the AI engine comprises an unsupervised machine learning model.

10. The system according to claim 9, wherein said unsupervised machine learning model comprises clustering or dimensionality reduction.

11. The system according to claim 1, wherein each of said electronic devices has a graphical user interface loadable on a corresponding display of the electronic device and configured to receive input data from the operators.

12. The system according to claim 1, wherein each of said electronic devices has an audio interface configured to acquire audio signals.

13. The system according to claim 1, wherein each of said electronic devices has a video camera configured to acquire photos and/or videos.

14. A method for diagnosing and solving faults in production plants where a plurality of sensors is arranged, the method comprising the following steps carried out in one or more of the production plants:
generating failure events in response to receiving values of physical parameters or variables detected by said sensors;
identifying root causes of failure among the failure events;
storing of the failure events and of the identified root causes of failure in a plant database;
determining at least one proposed maintenance action by processing the root causes of failure stored in the plant database;
generating a proposed maintenance message representative of the at least one proposed maintenance action and transmitting said proposed maintenance message to at least one electronic device for being displayed to an operator;
in response to a confirm by the operator of having adopted the proposed maintenance action, increasing a counter associated to said proposed maintenance action in a fault feedback database configured to store the proposed maintenance actions and their rate of use;
in response to the operator having adopted a maintenance action which differs from the proposed maintenance action, recording data of the adopted maintenance action in the fault feedback database,
the method further comprising the following steps carried out in a server side in communication with the production plants:
receiving at a cross-fleet database the rates of use of the proposed maintenance actions and/or the adopted maintenance actions coming from the fault feedback databases of the production plants;
generating by an AI engine a new proposed action upon receiving an adopted maintenance action from the crosse fleet database;
evaluating the new proposed action before transforming it into a proposed maintenance action.

15. The method of claim 14, wherein the step of evaluating the new proposed action before transforming it into a proposed maintenance action comprises the steps of:
revising the new proposed action in response to a disapproval of the new proposed action;
storing the approved or revised proposed action in the cross-fleet database as a proposed maintenance action in response to an approval of the new proposed action or in response to a revision;
transmitting the proposed maintenance actions and their rates of use from the cross-fleet database to the fault feedback databases of the production plants;
receiving and storing in the fault feedback databases the proposed maintenance actions and their rates of use.

16. A computer program product having instructions which, when executed by a computer device or system, cause the computing device or system to perform the method according to claim 14.
